(19) United States
(12) Patent Application Publication
(10) Pub. No.: US 2017/0220388 A1
(43) Pub. Date: Aug. 3, 2017

(54) RESOURCE PROCESSING METHOD AND DEVICE

(71) Applicant: ALIBABA GROUP HOLDING LIMITED, GRAND CAYMAN (KY)

(72) Inventors: YUEYANG CHEN, HANGZHOU (CN); WEIXIONG ZHANG, HANGZHOU (CN)

(21) Appl. No.: 15/492,840

(22) Filed: Apr. 20, 2017

Related U.S. Application Data
(63) Continuation of application No. PCT/CN2015/091691, filed on Oct. 10, 2015.

(30) Foreign Application Priority Data
Oct. 21, 2014 (CN) 201410562521.6

(51) Int. Cl. G06F 9/50; G06F 9/52

(52) U.S. Cl. CPC G06F 9/5016; G06F 9/528; G06F 2209/5022

(57) ABSTRACT

A resource processing method and device, the method comprising: establishing, according to a first resource storage for storing a target resource, a corresponding second resource storage, the second resource storage comprising resource record information of the target resource; according to a resource display mode corresponding to the first resource storage, displaying the resource record information of the target resource; if the target resource is received by the first resource storage, updating the first resource storage according to the second resource storage. The method establishes a second resource storage corresponding to a first resource storage, and obtains and displays resource record information of a target resource, thus reasonably arranging a resource allocation flow path according to a resource acquisition condition, supporting the advance allocation of resource in transit and shortening resource vacancy time, and increasing resource allocation efficiency and resource utilization rate.

### CROSS-REFERENCE TO RELATED APPLICATIONS

This application is a continuation application of international Application No. PCT/CN2015/091691, filed on Oct. 10, 2015, which claims priority to and benefits of Chinese Patent Application No. 201410562521.6, filed on Oct. 21, 2014. The contents of the above-referenced applications are incorporated herein by reference in their entirety.

### TECHNICAL FIELD

The present application relates to the field of computers, and in particular, to a resource processing technology.

### BACKGROUND ART

In the prior art, generally, only available resources can be allocated; the resources that have not yet been obtained or are to be obtained cannot be used for allocation, but can be allocated only when the state thereof changes to available. Evidently, allocating the resources when the state thereof changes to available not only prolongs resource vacancy time, but also affects resource allocation efficiency and reduces resource utilization rate.

### SUMMARY

An objective of the present application is to provide a resource processing method and device. According to one aspect of the present application, a resource processing method is provided, including: establishing, according to a first resource storage for storing a target resource, a corresponding second resource storage, wherein the second resource storage includes resource record information of the target resource; according to a resource display mode corresponding to the first resource storage, displaying the resource record information of the target resource; and if the target resource is received by the first resource storage, updating the first resource storage according to the second resource storage.

According to another aspect of the present application, a resource processing device is further provided, including: a first unit, configured to establish, according to a first resource storage for storing a target resource, a corresponding second resource storage, wherein the second resource storage includes resource record information of the target resource; a second unit, configured to, according to a resource display mode corresponding to the first resource storage, display the resource record information of the target resource; and a third unit, configured to, if the target resource is received by the first resource storage, update the first resource storage according to the second resource storage.

The present application establishes a second resource storage corresponding to a first resource storage planned to store a target resource, the second resource storage including resource record information of the target resource in the first resource storage, then achieves more reasonable resource processing and allocation based on expression and display of the resource record information, and when the target resource is received, updates the related resource record information of the target resource recorded in the second resource storage to the first resource storage. Here, the present application can reasonably arrange a resource allocation flow path according to a resource acquisition condition, such as supporting the advance allocation of resource in transit and shortening resource vacancy time, thus increasing resource allocation efficiency and resource utilization rate.

### BRIEF DESCRIPTION OF THE DRAWINGS

Other features, objectives and advantages of the present application will become more evident by reading detailed descriptions made about non-restrictive embodiments with reference to the following accompanying drawings:

FIG. 1 is a schematic diagram of a resource processing device according to one aspect of the present application; and

FIG. 2 is a flow chart of a resource processing method according to another aspect of the present application.

The same or similar reference signs in the accompanying drawings represent the same or similar members.

### DETAILED DESCRIPTION

The present application is further described in detail below with reference to the accompanying drawings.

In a typical configuration of the present application, a terminal, a service network device and a trusted party each include one or more processors (CPU), an input/output interface, a network interface, and a memory.

The memory may include a volatile memory, a random access memory (RAM) and/or a non-volatile memory or the like in a computer readable medium, for example, a read-only memory (ROM) or a flash RAM. The memory is an example of the computer readable medium.

The computer readable medium includes non-volatile and volatile media as well as movable and non-movable media, and can implement information storage by means of any method or technology. Information may be a computer readable instruction, a data structure, a module of a program, or other data. For example, a storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to a computing device. According to the definition of this text, the computer readable medium does not include transitory media, such as a modulated data signal and a carrier.

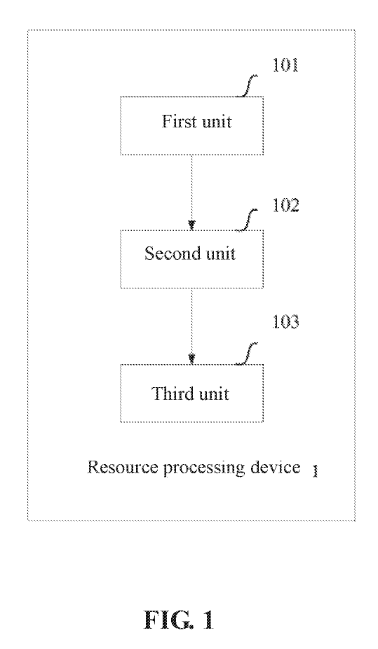

FIG. 1 is a schematic diagram of a resource processing device according to one aspect of the present application. The resource processing device 1 includes a first unit 101, a second unit 102, and a third unit 103.

The first unit 101 establishes, according to a first resource storage for storing or planned to store a target resource (e.g., a resource to be obtained), a corresponding second resource storage, wherein the second resource storage includes resource record information of the target resource; the second unit 102, according to a resource display mode corresponding to the first resource storage, displays the resource record information of the target resource; and the third unit 103, if the target resource is received, then updates the first resource storage according to the second resource storage. The target resource refers to a resource that is to be obtained by the first resource storage, for example, a resource in transit. The target resource may be later obtained by the first resource storage.

Specifically, the first unit 101 of the resource processing device 1 establishes, according to a first resource storage planned to store a target resource, a second resource storage, wherein the second resource storage includes resource record information of the target resource. The first resource storage is a storage preset for a target resource and going to store the target resource. For example, when the target resource is a trading commodity, the first resource storage is a warehouse of actually purchased commodities, and the purchased commodities will arrive to the first resource storage through transportation in transit. The second resource storage is a storage that corresponds to the first resource storage and includes resource record information of the target resource, relative to that the first resource storage is a warehouse storing material objects, the second resource storage does not store material objects, but keeps and records data information such as resource record information of the target resource in a period from purchase to entering the first resource storage. The resource record information of the target resource includes data information related to the target resource, for example, inventory information of the target resource, allocation information of the target resource, timeliness information of the target resource, a warehouse address of the target resource, and so on. In the resource record information of the target resource in the second resource storage, some information is completely inherited from resource information of the first resource storage, for example, the allocation information of the target resource, the warehouse address of the target resource, and so on; some other information is data information recorded by the second resource storage alone when the resource is in transit and has not yet arrived to the first resource storage, for example, the inventory information of the target resource, the timeliness information of the target resource, and so on. When the resource is in transit, the first resource storage cannot receive and store the resource and thus cannot record the corresponding foregoing information, while the second resource storage corresponding to the first resource storage is not subject to limitations of resource receiving and can record, in real time, related data information changes of the resource in transit.

Those skilled in the art should be able to understand that the resource record information of the target resource is merely exemplary, and other related data information, if applicable to the present application, should also be included within the protection scope of the present application and is incorporated here by means of reference.

Preferably, the target resource includes a physical resource or virtual resource. The target resource may be a physical resource that occupies a physical space, for example, an ordinary physical commodity. The target resource may also be a non-physical resource, for example, information resource edited by using a database or a program, or data information used to represent a controlled physical resource, for example, quantity of electricity, natural gas consumption, and so on. At the same time, both the physical resource and the virtual resource are not limited to commodities for trading and deal, and the solution is applicable to all other resources waiting for allocation and processing.

Preferably, the first unit 101 receives resource acquisition indication information; determines, according to the resource acquisition indication information, the first resource storage planned to store the corresponding target resource; and establishes a corresponding second resource storage according to the first resource storage, wherein the second resource storage includes the resource record information of the target resource.

Specifically, at first, resource acquisition indication information is received. Resource acquisition indication information is obtained based on an actual need. For example, a merchant purchases a corresponding commodity according to his/her own actual sale need, for example, information such as the type and the number of the commodity to be purchased, as well as the manufacturer and the vendor corresponding to the purchase all belongs to the resource acquisition indication information. Then, the first resource storage planned to store the corresponding target resource is determined according to the resource acquisition indication information. For example, the merchant decides to store a certain batch of purchased commodities into a first resource storage A1 Storage, that is, after purchase, the commodities, after transportation in transit, will be stored in the first resource storage A1 Storage. Next, a corresponding second resource storage is established according to the first resource storage, wherein the second resource storage includes the resource record information of the target resource. For example, a second resource storage A2 Storage corresponding to the first resource storage A1 Storage is established, wherein, some resource record information corresponding to the target resource in the second resource storage A2 Storage is inherited from resource information of the first resource storage A1 Storage. For example, a commodity object to be purchased in the first resource storage A1 Storage is a commodity object recorded in the second resource storage A2 Storage. For another example, allocation information of a target commodity, a warehouse address of the target commodity and other information of the first resource storage A1 Storage are inherited by the second resource storage A2 Storage, and the resource information initially corresponds to the first resource storage A1 Storage of the target commodity and at the same time, is embodied by the second resource storage A2 Storage. Here, the first resource storage and the second resource storage may be connected in this way during resource acquisition, for example, during commodity purchase: completing purchase of a commodity based on the resource acquisition indication information and the corresponding first resource storage, upon confirmation of completion of the purchase, finding a second resource storage corresponding to the first resource storage, and updating resource record information of a target commodity to the second resource storage. For example, N pieces of G-type commodities are purchased for the first resource storage, and at this point, the corresponding second resource storage records resource record information of the target commodity, including: N pieces of G-type commodities, a warehouse of the target commodity being the first resource storage, an available distribution range of the target resource, timeliness information of the target commodity and other related data information. Once new resource acquisition indication information is received, corresponding resource record information of the corresponding second resource storage is updated in real time accordingly. Here, only when the target resource indeed arrives, can the corresponding data information of the first resource storage change, while the second resource storage may record and update, in real time, the related resource record information when the target resource is in transit.

Next, the second unit 102 of the resource processing device 1, according to a resource display mode corresponding to the first resource storage, displays the resource record information of the target resource. Here, the first resource storage may display and express a resource stored therein to a corresponding object in a certain way. For example, when an ordinary commodity is stored in the first resource storage, the first resource storage is a physical warehouse for the merchant to store commodities, and for the commodities stored in the warehouse, the merchant needs to provide related information of commodities for a certain object, e.g., consumers, through a certain channel such as physical store sale. Further, preferably, in electronic commerce, related information of commodities in the first resource storage can be, via a network, displayed to a network front end and provided for consumers to browse and select. Here, the first resource storage displays related information of resources existing in the storage, and at the same time, the second resource storage includes the resource record information of the target resource in transit. As the second resource storage is corresponding to the first resource storage, the resource record information of the target resource may be displayed with reference to the resource display mode corresponding to the first resource storage, that is, the information of the second resource storage can be displayed to the corresponding consumers at the same time. For example, on an electronic trading platform, the target resource is a trading commodity, purchase of the commodity is completed, and the corresponding resource record information is updated in the corresponding second resource storage. At the same time, the device 1 displays the corresponding resource record information in the second resource storage on a commodity trading page of the electronic trading platform. For example, for a certain commodity D, there is now an in-transit inventory of M pieces, it is estimated that the goods will take Y days to arrive to the corresponding first resource storage, and the corresponding distribution range may be a, b, c . . . and other regions. In this way, the resources in transit that cannot be processed originally can be processed and arranged in advance. In addition, more generally, for the commodity D, the corresponding first resource storage has owned an actual inventory of L pieces, the second resource storage further has an in-transit inventory of M pieces, it is estimated that the in-transit inventory of M pieces takes Y days to arrive to the corresponding first resource storage, and the corresponding distribution range may be a, b, c . . . and other regions. At this point, the resource record information can be provided for front-end consumers at the same time, and the total amount of the inventory of such commodities that the consumers can expect could reach L+M pieces, and further, the inventory of L pieces existing in the first resource storage may be set to be distributed to consumers in need in preference to the in-transit inventory of M pieces.

Next, the third unit 103 of the resource processing device 1, if the target resource is received, then updates the first resource storage according to the second resource storage. Here, when the target resource arrives to the first resource storage, as the resource record information of the target resource in transit is recorded in the second resource storage, resource information corresponding to the first resource storage may be updated according to the resource record information recorded in the second resource storage. For example, a certain commodity E is recorded in the second resource storage, it is confirmed that the inventory is X when the commodity arrives to the corresponding first resource storage, and the corresponding distribution range may be a, b, c . . . and other regions. At this point, related information of the commodity E in the second resource storage can be updated to the first resource storage, Here, that the first resource storage is updated by using resource record information of a target commodity E (e.g., a to-be-obtained commodity) corresponding to the second resource storage is because the second resource storage records real-time information of the target commodity E, and after the target resource enters the first resource storage, a corresponding resource information display mode will be provided by the first resource storage. Therefore, through the updating operation, it can be ensured that the handed-over resource record information displayed after the commodity enters the first resource storage is real-time and accurate. For example, it is predetermined that there are Y pieces of commodities to be purchased, but the inventory of the commodities actually arrived the first resource storage is X pieces. There are many reasons for such an error, which may be that the commodities are missed during purchase and delivery, that the commodities are damaged on the way, or the like. Updating the first resource storage through the second resource storage can ensure that the related resource information recorded when the first resource storage receives the target resource is in line with the actual condition.

Preferably, the updating the first resource storage according to the second resource storage includes: obtaining an exclusive lock of the second resource storage; transferring the resource record information of the received target resource in the second resource storage into the first resource storage; and releasing the exclusive lock of the second resource storage.

Specifically, when an operation obtains an exclusive lock of the second resource storage, only the operation can operate the resource record information in the second resource storage, the exclusive lock of the second resource storage can only be allocated to one operation in the same time period, and before the operation ends and the exclusive lock is released, all other operations for the resource record information of the second resource storage have to wait. On this basis, in a distributed cluster environment, through such a technical arrangement as exclusive lock, it is ensured that updating of the resource record information, for example, updating of the commodity inventory, can be performed in order, thus solving the problem of incorrect commodity inventory caused by concurrent updating. Here, after the updating operation obtains an exclusive lock of the second resource storage, the resource record information of the target resource in the second resource storage can be transferred into the first resource storage smoothly, ensuring that the related resource information of the first resource storage is real-time and accurate. Moreover, upon completion of the transferring and updating operations, the exclusive lock is released, such that running of other operations for the second resource storage is not affected.

Here, the present application establishes a second resource storage corresponding to a first resource storage planned to store a target resource, the second resource storage including resource record information of the target resource in the first resource storage, then achieves more reasonable resource processing and allocation based on expression and display of the resource record information, and when the target resource is received, Updates the related resource record information of the target resource recorded in the second resource storage to the first resource storage. Here, the present application can reasonably arrange a resource allocation flow path according to a resource acquisition condition, such as supporting the advance allocation of resource in transit and shortening resource vacancy time, thus increasing resource allocation efficiency and resource utilization rate.

In a preferred embodiment, the resource record information of the target resource includes resource timeliness information corresponding to the target resource.

Specifically, the resource timeliness information changes in real time. When the target resource is obtained, for example, upon completion of purchase of a target commodity, the second resource storage records resource record information of the target commodity at this point, including timeliness information of the target resource. The resource timeliness information can help determine a corresponding state of the target resource, for example, real-time time and place of the target resource, the time when the target resource is expected to arrive to a determined position, and other related conditions. Then, a person in need of the target resource, for example, a commodity trading consumer, can form an expectation for the commodity through the timeliness information of the target resource and send a corresponding request. Here, the timeliness information may include estimated time when the commodity arrives to the corresponding first resource storage, for example, it is estimated that the commodity takes D days to arrive to the first resource storage; it may also include estimated time when the commodity is sent to an object in need such as a corresponding consumer, for example, it is estimated that it takes F days to send the commodity to the corresponding consumer. In addition, the timeliness information may also be precise to different time units such as month, day, and hour according to an actual situation.

Those skilled in the art should be able to understand that the resource timeliness information includes, but is not limited to, the examples, and other related data information, if capable of reflecting the resource timeliness information and applicable to the present application, should also be included within the protection scope of the present application, and is incorporated herein by means of reference.

Preferably, the resource record information of the target resource further includes resource allocation information corresponding to the target resource.

Specifically, the resource allocation information is that to which regions the corresponding target resource in the second resource storage can be distributed. Here, the resource allocation information may be displayed to a person in need of the resource through a certain resource display mode. For example, in electronic commerce, resource allocation information of a target commodity may be displayed to the consumer of the target commodity in a network front end. Further, the corresponding resource allocation information may be displayed according to personalized information of the person in need of the resource, for example, according to personalized information of the commodity consumer, such that matching of information resources is more targeted and better user experience is provided. For example, according to personal information registered on an electronic commerce platform system, by the commodity consumer, for example, delivery address information of the commodity, whether the delivery address information is included in the resource allocation information of the target commodity may be automatically judged. For another example, the resource allocation information corresponding to the target commodity, for example, a region where the target commodity can be distributed, can also be displayed on a front end webpage, for the consumer to select and view on his/her own while browsing the commodity.

More preferably, the resource allocation information is inherited from resource allocation information in the first resource storage.

Specifically, the second resource storage is established based on the first resource storage, and some information in the resource record information of the target resource corresponding thereto is inherited from the corresponding first resource storage, for example, allocation information of the target resource, a warehouse address of the target resource, a merchant subscription relationship, and so on. Here, preferably, the allocation information of the target resource is inherited from the resource allocation information in the first resource storage. The resource record information of the second resource storage actually fills in vacancy displayed instantly by the corresponding resource information when the target resource is in transit, and the second resource storage does not really own the target resource, but the second resource storage can process and arrange the target resource in advance, for example, arrange the target commodity for front-end sale. Real execution of the arrangement can be operated only after the target resource enters the corresponding first resource storage. At this point, connection of resource information updates may be performed between the second resource storage and the first resource storage. At the same time, in order to ensure that, after the target resource enters the first resource storage, the first resource storage can smoothly execute advance processing and arrangement performed on the resource by the second resource storage, some basic information of the second resource storage has to keep an inheriting and consistent relationship with the corresponding first resource storage; otherwise, an error may occur in a specific execution process. For example, allocation information of a first resource storage U1 is that the resource may be distributed to regions a, b, and c; allocation information of a corresponding second resource storage U2 is different from that of the first resource storage U1, in that the resource is distributed to regions a, b, and d; if the second resource storage U2 makes an advance processing and arrangement when the resource is in transit, for example, a certain resource is distributed to the region c, when the resource arrives to the first resource storage U1, the advance processing and arrangement cannot be further processed, because resource allocation information of the first resource storage U1 does not include the region c, and the resource that has entered the first resource storage U1 cannot be distributed to the region c, and thus a connection fault occurs in processing and arrangement of the target resource and normal operation is impossible.

In another preferred embodiment, if a distribution request for the target resource is received, a fourth unit (not shown) of the resource processing device 1 generates to-be-distributed information corresponding to the target resource according to the distribution request.

Specifically, the resource record information of the target resource corresponding to the second resource storage may be displayed in a certain mode. For example, in electronic commerce, a merchant may display resource record information, such as actual inventory, in-transit inventory, and timeliness information, of a commodity in a front end webpage of an electronic commerce platform. Further, a person in need of the resource, for example, a consumer of the commodity, may make a distribution request based on obtained display information of the commodity. For example, the consumer places an order in a front end network to pick out and buy the commodity. Afterwards, to-be-distributed information corresponding to the target resource is generated according to the distribution request, for example, information indicating that the commodity has been sold and delivery will be made after the commodity arrives to the corresponding first resource storage.

In this process, the resource record information of the target resource changes. Inventory information of the target resource is taken as an example. For example, at a certain time, a to-be-sold inventory of commodity K of the second resource storage S2 is w1 pieces, a withholding inventory is 0 pieces, and an occupied inventory is 0 pieces. Then, the consumer places an order to pick out and buy I piece of the commodity K, and at this point, the to-be-sold inventory corresponding to the commodity K of the second resource storage S2 becomes w1-1 pieces, the withholding inventory becomes 1 piece, and the occupied inventory is still 0 pieces. When the consumer makes payment and the to-be-distributed information is generated, the to-be-sold inventory corresponding to the commodity K of the second resource storage S2 becomes w1-1 pieces, the withholding inventory becomes 0 pieces, and the occupied inventory becomes 1 piece. At this point, the occupied inventory is corresponding to the to-be-distributed information.

Preferably, the third unit 103 of the resource processing device 1 further distributes the corresponding target resource in the first resource storage to a user corresponding to the distribution request according to the to-be-distributed information, and correspondingly updates the first resource storage information and the to-be-distributed information.

Specifically, when the resource is in transit, to-be-distributed information corresponding to the target resource is generated based on the received distribution request, and after the target resource in the corresponding second resource storage enters the first resource storage, it is necessary to distribute the resource based on the to-be-distributed information. Here, preferably, resource information, of the target resource, corresponding to the to-be-distributed information is locked. For example, inventory information is locked, that is, the locked inventory is only matched with the corresponding to-be-distributed information, to ensure that a user corresponding to the to-be-distributed information can obtain the corresponding resource smoothly. For example, when a certain commodity J arrives to the first resource storage, the corresponding to-be-sold inventory is w1-n pieces, the withholding inventory becomes 0 pieces, and the occupied inventory becomes n pieces. Then, according to the to-be-distributed information, there are n pieces of commodities J waiting for delivery, that is, an inventory of n pieces of the arrived commodities J is locked, and the inventory of n pieces needs to be distributed to the user corresponding to the to-be-distributed information.

At this point, the first resource information and the to-be-distributed information may be changed and updated in real time with an actual distribution condition of the corresponding resource, for example, a commodity delivery condition. The to-be-distributed information minus the target resource that has been delivered is the updated to-be-distributed information. Likewise, the first resource storage information minus the target resource that has been delivered is the updated first resource storage information. At this point, the first resource storage includes a target resource updated and entered from the corresponding second resource storage, and also includes the target resource that has already existed in the first resource storage.

Preferably, the generating to-be-distributed information corresponding to the target resource according to the distribution request further includes: updating available information of the target resource in the second resource storage according to the to-be-distributed information.

Specifically, here, the available information of the target resource includes a vendible inventory. Upon completion of purchase of the target resource, the second resource storage may record an initial inventory of the target resource, but an abnormity may actually occur in the target resource. For example, it is predetermined that there are Y pieces of commodities to be purchased, but the inventory actually arrived the first resource storage is X pieces. There are many reasons for such an error, which may be that the commodities are missed during purchase and delivery, that the commodities are damaged on the way, or the like. At this point, if a certain reasonable adjustment number is set for the initial inventory and a difference between the initial inventory and the adjustment number is used as an actual vendible inventory, as long as the actual abnormal inventory is within the range of the set adjustment number, it can avoid a situation that a corresponding allocation operation cannot be completed according to the generated to-be-distributed information due to abnormity of the target resource. That is, possible abnormal inventory situations are tolerated by setting an adjustment number. Further, the vendible inventory may be updated in real time with the condition of the to-be-distributed information, that is, the inventory locked by the to-be-distributed information needs to be deducted from the vendible inventory. In addition, the coping method of the abnormal condition of the target resource further includes other manners, for example, an inventory of another warehouse is allotted for remedy and so on.

Those skilled in the art should be able to understand that the available information of the target resource is merely exemplary, and other related data information, if applicable to the present application, should also be included within the protection scope of the present application and is incorporated herein by means of reference.

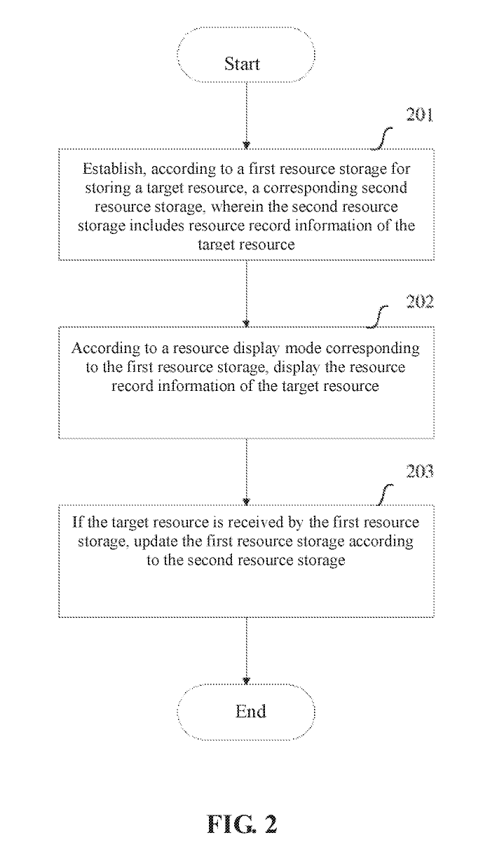

FIG. 2 is a flow chart of a resource processing method according to another aspect of the present application.

In step S201, the resource processing device 1 establishes, according to a first resource storage planned to store a target resource, a corresponding second resource storage, wherein the second resource storage includes resource record information of the target resource. In step S202, the resource processing device 1, according to a resource display mode corresponding to the first resource storage, displays the resource record information of the target resource. In step S203, the resource processing device 1, if the target resource is received, then updates the first resource storage according to the second resource storage.

Specifically, in step S201, the resource processing device 1 establishes, according to a first resource storage planned to store a target resource, a corresponding second resource storage, wherein the second resource storage includes resource record information of the target resource. The first resource storage is a storage preset for a target resource and going to store the target resource. For example, when the target resource is a trading commodity, the first resource storage is a warehouse of actually purchased commodities, and the purchased commodities will arrive to the first resource storage through transportation in transit. The second resource storage is a storage that corresponds to the first resource and includes resource record information of the target resource. Relative to that the first resource storage is a warehouse storing material objects, the second resource storage does not store material objects, but keeps and records data information such as resource record information of the target resource in a period from purchase to entering the first resource storage. The resource record information of the target resource includes data information related to the target resource, for example, inventory information of the target resource, allocation information of the target resource, timeliness information of the target resource, a warehouse address of the target resource, and so on. In the resource record information of the target resource in the second resource storage, some information is completely inherited from resource information of the first resource storage, for example, the allocation information of the target resource, the warehouse address of the target resource, and so on; some other information is data information recorded by the second resource storage alone when the resource is in transit and has not yet arrived to the first resource storage, for example, the inventory information of the target resource, the timeliness information of the target resource, and so on. When the resource is in transit, the first resource storage cannot receive and store the resource and thus cannot record the corresponding foregoing information, while the second resource storage corresponding to the first resource storage is not subject to limitations of resource receiving and can record, in real time, related data information changes of the resource in transit.

Those skilled in the art should be able to understand that the resource record information of the target resource is merely exemplary, and other related data information, if applicable to the present application, should also be included within the protection scope of the present application and is incorporated herein by means of reference.

Preferably, the target resource includes a physical resource or virtual target resource. The target resource may be a physical resource that occupies a physical space, for example, an ordinary physical commodity. The target resource may also be a non-physical resource, for example, information resource edited by using a database or a program, or data information used to represent a controlled physical resource, for example, quantity of electricity, natural gas consumption and so on. At the same time, both the physical resource and the virtual resource are not limited to commodities for trading and deal, and the solution is applicable to all other resources waiting for allocation and processing.

Preferably, in step S201, the resource processing device 1 receives resource acquisition indication information; determines, according to the resource acquisition indication information, the first resource storage planned to store the corresponding target resource; and establishes a corresponding second resource storage according to the first resource storage, wherein the second resource storage includes the resource record information of the target resource.

Specifically, at first, the resource processing device 1 receives resource acquisition indication information. Resource acquisition indication information is obtained based on an actual need. For example, a merchant purchases a corresponding commodity according to his/her own actual sale need, and information such as the type and the number of the commodity to be purchased, as well as the manufacturer and the vendor corresponding to the purchase all belongs to the resource acquisition indication information. Then, the resource processing device 1 determines the first resource storage planned to store the corresponding target resource according to the resource acquisition indication information. For example, the merchant decides to store a certain batch of purchased commodities into a first resource storage A1 Storage, that is, after purchase, the commodities, after transportation in transit, will be stored in the first resource storage A1 Storage. Next, the resource processing device 1 establishes a corresponding second resource storage according to the first resource storage, wherein the second resource storage includes the resource record information of the target resource. For example, a second resource storage A2 Storage corresponding to the first resource storage A1 Storage is established, wherein, some resource record information corresponding to the target resource in the second resource storage A2 Storage is inherited from resource information of the first resource storage A1 Storage. For example, a commodity object to be purchased in the first resource storage A1 Storage is a commodity object recorded in the second resource storage A2 Storage. For another example, allocation information of a target commodity, a warehouse address of the target commodity and other information of the first resource storage A1 Storage are inherited by the second resource storage A2 Storage, and the resource information initially corresponds to the first resource storage A1 Storage of the target commodity and at the same time, is embodied by the second resource storage A2 Storage. Here, the first resource storage and the second resource storage may be connected in this way during resource acquisition, for example, during commodity purchase: completing purchase of a commodity based on the resource acquisition indication information and the corresponding first resource storage, upon confirmation of completion of the purchase, finding a second resource storage corresponding to the first resource storage, and updating resource record information of a target commodity to the second resource storage. For example, N pieces of G-type commodities are purchased for the first resource storage, and at this point, the corresponding second resource storage records resource record information of the target commodity, including: N pieces of G-type commodities, a warehouse of the target commodity being the first resource storage, an available distribution range of the target resource, timeliness information of the target commodity and other related data information. Once new resource acquisition indication information is received, corresponding resource record information of the corresponding second resource storage is updated in real time accordingly. Here, only when the target resource indeed arrives, can the corresponding data information of the first resource storage change, while the second resource storage may record and update, in real time, the related resource record information when the target resource is in transit.

Next, in step S202, the resource processing device 1, according to a resource display mode corresponding to the first resource storage, displays the resource record information of the target resource. Here, the first resource storage may display and express a resource stored therein to a corresponding object in a certain way. For example, when an ordinary commodity is stored in the first resource storage, the first resource storage is a physical warehouse for the merchant to store commodities, and for the commodities stored in the warehouse, the merchant needs to provide related information of commodities for a certain object, e.g., consumers, through a certain channel, such as physical store sale. Further, preferably, in electronic commerce, related information of commodities in the first resource storage can be, via a network, displayed to a network front end and provided for consumers to browse and select. Here, the first resource storage displays related information of resources existing in the storage, and at the same time, the second resource storage includes the resource record information of the target resource in transit. As the second resource storage is corresponding to the first resource storage, the resource record information of the target resource may be displayed with reference to the resource display mode corresponding to the first resource storage, that is, the information of the second resource storage can be displayed to the corresponding consumers at the same time. For example, on an electronic trading platform, the target resource is a trading commodity, purchase of the commodity is completed, and the corresponding resource record information is updated in the corresponding second resource storage. At the same time, the device 1 displays the corresponding resource record information in the second resource storage on a commodity trading page of the electronic trading platform. For example, for a certain commodity D, there is now an in-transit inventory of M pieces, it is estimated that the goods will take Y days to arrive to the corresponding first resource storage, and the corresponding distribution range may be a, b, c . . . and other regions. In this way, the resources in transit that cannot be processed originally can be processed and arranged in advance. In addition, more generally, for the commodity D, the corresponding first resource storage has owned an actual inventory of L pieces, the second resource storage further has an in-transit inventory of M pieces, it is estimated that the in-transit inventory of M pieces takes Y days to arrive to the corresponding first resource storage, and the corresponding distribution range may be a, b, c . . . and other regions. At this point, the resource record information can be provided for front-end consumers at the same time, and the total amount of the inventory of such commodities that the consumers can expect could reach L+M pieces, and further, the inventory of L pieces existing in the first resource storage may be set to be distributed to consumers in need in preference to the in-transit inventory of M pieces.

Next, in step S203, the resource processing device 1, if the target source is received, then updates the first resource storage according to the second resource storage. Here, when the target resource arrives to the first resource storage, as the resource record information of the target resource in transit is recorded in the second resource storage, resource information corresponding to the first resource storage may be updated according to the resource record information recorded in the second resource storage. For example, a certain commodity E is recorded in the second resource storage, it is confirmed that the inventory is X when the commodity arrives to the corresponding first resource storage, and the corresponding distribution range may be a, b, c . . . and other regions. At this point, related information of the commodity E in the second resource storage can be updated to the first resource storage. Here, that the first resource storage is updated by using resource record information of a target commodity E corresponding to the second resource storage is because the second resource storage records real-time information of the target commodity E, and after the target resource enters the first resource storage, a corresponding resource information display mode will be provided by the first resource storage. Therefore, through the updating operation, it can be ensured that the handed-over resource record information displayed after the commodity enters the first resource storage is real-time and accurate. For example, it is predetermined that there are Y pieces of commodities to be purchased, but the inventory of the commodities actually arrived the first resource storage is X pieces. There are many reasons for such an error, which may be that the commodities are missed during purchase and delivery, that the commodities are damaged on the way, or the like. Updating the first resource storage through the second resource storage can ensure that the related resource information recorded when the first resource storage receives the target resource is in line with the actual condition.

Preferably, the updating the first resource storage according to the second resource storage includes: obtaining an exclusive lock of the second resource storage; transferring the resource record information of the received target resource in the second resource storage into the first resource storage; and releasing the exclusive lock of the second resource storage.

Specifically, when an operation obtains an exclusive lock of the second resource storage, only the operation can operate the resource record information in the second resource storage. The exclusive lock of the second resource storage can only be allocated to one operation in the same time period, and before the operation ends and the exclusive lock is released, all other operations for the resource record information of the second resource storage have to wait. On this basis, in a distributed cluster environment, through such a technical arrangement as exclusive lock, it is ensured that updating of the resource record information, for example, updating of the commodity inventory, can be performed in order, thus solving the problem of incorrect commodity inventory caused by concurrent updating. Here, after the updating operation obtains an exclusive lock of the second resource, the resource record information of the target resource in the second resource storage can be transferred into the first resource storage smoothly, ensuring that the related resource information of the first resource storage is real-time and accurate. Moreover, upon completion of the transferring and updating operations, the exclusive lock is released, such that running of other operations for the second resource storage is not affected.

Here, the present application establishes a second resource storage corresponding to a first resource storage planned to store a target resource, the second resource storage including resource record information of the target resource in the first resource storage, then achieves more reasonable resource processing and allocation based on expression and display of the resource record information, and when the target resource is received, updates the related resource record information of the target resource recorded in the second resource storage to the first resource storage. Here, the present application can reasonably arrange a resource allocation flow path according to a resource acquisition condition, such as supporting the advance allocation of resource in transit and shortening resource vacancy time, thus increasing resource allocation efficiency and resource utilization rate.

In a preferred embodiment, the resource record information of the target resource includes resource timeliness information corresponding to the target resource.

Specifically, the resource timeliness information changes in real time. When the target resource is obtained, for example, upon completion of purchase of a target commodity, the second resource storage records resource record information of the target commodity at this point, including timeliness information of the target resource. The resource timeliness information can help determine a corresponding state of the target resource, for example, real-time time and place of the target resource, the time when the target resource is expected to arrive to a determined position, and other related conditions. Then, a person in need of the target resource, for example, a commodity trading consumer, can form an expectation for the commodity through the timeliness information of the target resource and send a corresponding request. Here, the timeliness information may include estimated time when the commodity arrives to the corresponding first resource storage, for example, it is estimated that the commodity takes D days to arrive to the first resource storage; it may also include estimated time when the commodity is sent to an object in need such as a corresponding consumer, for example, it is estimated that it takes F days to send the commodity to the corresponding consumer. In addition, the timeliness information may also be precise to different time units such as month, day, and hour according to an actual situation.

Those skilled in the art should be able to understand that the resource timeliness information includes, but is not limited to, the examples, and other related data information, if capable of reflecting the resource timeliness information and applicable to the present application, should also be included within the protection scope of the present application, and is incorporated herein by means of reference.

Preferably, the resource record information of the target resource further includes resource allocation information corresponding to the target resource.

Specifically, the resource allocation information is that to which regions the corresponding target resource in the second resource storage can be distributed. Here, the resource allocation information may be displayed to a person in need of the resource through a certain resource display mode. For example, in electronic commerce, resource allocation information of a target commodity may be displayed to the consumer of the target commodity in a network front end. Further, the corresponding resource allocation information may be displayed according to personalized information of the person in need of the resource, for example, according to personalized information of the commodity consumer, such that matching of information resources is more targeted and better user experience is provided. For example, according to personal information registered on an electronic commerce platform system, by the commodity consumer, for example, delivery address information of the commodity, whether the delivery address information is included in the resource allocation information of the target commodity may be automatically judged. For another example, the resource allocation information corresponding to the target commodity, for example, a region where the target commodity can be distributed, can also be displayed on a front end webpage, for the consumer to select and view on his/her own while browsing the commodity.

More preferably, the resource allocation information is inherited from resource allocation information in the first resource storage.

Specifically, the second resource storage is established based on the first resource storage, and sonic information in the resource record information of the target resource corresponding thereto is inherited from the corresponding first resource storage, for example, allocation information of the target resource, a warehouse address of the target resource, a merchant subscription relationship, and so on. Here, preferably, the allocation information of the target resource is inherited from the resource allocation information in the first resource storage. The resource record information of the second resource storage actually fills in vacancy displayed instantly by the corresponding resource information when the target resource is in transit, and the second resource storage does not really own the target resource, but the second resource storage can process and arrange the target resource in advance, for example, arrange the target commodity for front-end sale. Real execution of the arrangement can be operated only after the target resource enters the corresponding first resource storage. At this point, connection of resource information updates may be performed between the second resource storage and the first resource storage. At the same time, in order to ensure that, after the target resource enters the first resource storage, the first resource storage can smoothly execute advance processing and arrangement performed on the resource by the second resource storage, some basic information of the second resource storage has to keep an inheriting and consistent relationship with the corresponding first resource storage; otherwise, an error may occur in a specific execution process. For example, allocation information of a first resource storage U1 is that the resource may be distributed to regions a, b, and c; allocation information of a corresponding second resource storage U2 is different from that of the first resource storage U1, in that the resource is distributed to regions a, b, and d; if the second resource storage U2 makes an advance processing and arrangement when the resource is in transit, for example, a certain resource is distributed to the region c, then, when the resource arrives to the first resource storage U1, the advance processing and arrangement cannot be further processed, because resource allocation information of the first resource storage U1 does not include the region c, and the resource that has entered the first resource storage U1 cannot be distributed to the region c, and thus a connection fault occurs in processing and arrangement of the target resource and normal operation is impossible.

In another preferred embodiment, if a distribution request for the target resource is received, in step S204 (not shown), the resource processing device 1 generates to-be-distributed information corresponding to the target resource according to the distribution request.

Specifically, the resource record information of the target resource corresponding to the second resource storage may be displayed in a certain mode. For example, in electronic commerce, a merchant may display resource record information, such as actual inventory, in-transit inventory, and timeliness information, of a commodity in a front end webpage of an electronic commerce platform. Further, a person in need of the resource, for example, a consumer of the commodity, may make a distribution request based on obtained display information of the commodity. For example, the consumer places an order in a front end network to pick out and buy the commodity. Afterwards, to-be-distributed information corresponding to the target resource is generated according to the distribution request, for example, information indicating that the commodity has been sold and delivery will be made after the commodity arrives to the corresponding first resource storage.

In this process, the resource record information of the target resource changes. Inventory information of the target resource is taken as an example. For example, at a certain time, a to-be-sold inventory of commodity K of the second resource storage S2 is w1 pieces, a withholding inventory is 0 pieces, and an occupied inventory is 0 pieces. Then, the consumer places an order to pick out and buy 1 piece of the commodity K, and at this point, the to-be-sold inventory corresponding to the commodity K of the second resource storage S2 becomes w1-1 pieces, the withholding inventory becomes 1 piece, and the occupied inventory is still 0 pieces. When the consumer makes payment and the to-be-distributed information is generated, the to-be-sold inventory corresponding to the commodity K of the second resource storage S2 becomes w1-1 pieces, the withholding inventory becomes 0 pieces, and the occupied inventory becomes 1 piece. At this point, the occupied inventory is corresponding to the to-be-distributed information.

Preferably, in step S203, the resource processing device 1 further distributes the corresponding target resource in the first resource storage to a user corresponding to the distribution request according to the to-be-distributed information, and correspondingly updates the first resource storage information and the to-be-distributed information.

Specifically, when the resource is in transit, to-be-distributed information corresponding to the target resource is generated based on the received distribution request, and after the target resource in the corresponding second resource storage enters the first resource storage, it is necessary to distribute the resource based on the to-be-distributed information. Here, preferably, resource information of the target resource corresponding to the to-be-distributed information is locked. For example, inventory information is locked, that is, the locked inventory is only matched with the corresponding to-be-distributed information, to ensure that a user corresponding to the to-be-distributed information can obtain the corresponding resource smoothly. For example, when a certain commodity J arrives to the first resource storage, the corresponding to-be-sold inventory is w1-n pieces, the withholding inventory becomes 0 pieces, and the occupied inventory becomes n pieces, then, according to the to-be-distributed information, there are n pieces of commodities J waiting for delivery. That is, an inventory of n pieces of the arrived commodities J is locked, and the inventory of n pieces needs to be distributed to the user corresponding to the to-be-distributed information.

At this point, the first resource information and the to-be-distributed information may be changed and updated in real time with an actual distribution condition of the corresponding resource, for example, a commodity delivery condition. The to-be-distributed information minus the target resource that has been delivered is the updated to-be-distributed information. Likewise, the first resource storage information minus the target resource that has been delivered is the updated first resource storage information. At this point, the first resource storage includes a target resource updated and entered from the corresponding second resource storage, and also includes the target resource that has already existed in the first resource storage.

Preferably, the generating to-be-distributed information corresponding to the target resource according to the distribution request further includes: updating available information of the target resource in the second resource storage according to the to-be-distributed information.

Specifically, here, the available information of the target resource includes a vendible inventory. Upon completion of purchase of the target resource, the second resource storage may record an initial inventory of the target resource, but an abnormity may actually occur in the target resource. For example, it is predetermined that there are Y pieces of commodities to be purchased, but the inventory actually arrived the first resource storage is X pieces, there are many reasons for such an error, which may be that the commodities are missed during purchase and delivery, that the commodities are damaged on the way, or the like. At this point, if a certain reasonable adjustment number is set for the initial inventory and a difference between the initial inventory and the adjustment number is used as an actual vendible inventory, as long as the actual abnormal inventory is within the range of the set adjustment number, it can avoid a situation that a corresponding allocation operation cannot be completed according to the generated to-be-distributed information due to abnormity of the target resource. That is, possible abnormal inventory situations are tolerated by setting an adjustment number. Further, the vendible inventory may be updated in real time with the condition of the to-be-distributed information, that is, the inventory locked by the to-be-distributed information needs to be deducted from the vendible inventory. In addition, the coping method of the abnormal condition of the target resource further includes other manners, for example, an inventory of another warehouse is allotted for remedy and so on.

Those skilled in the art should be able to understand that the available information of the target resource is merely exemplar, and other related data information, if applicable to the present application, should also be included within the protection scope of the present application and is incorporated herein by means of reference.

For those skilled in the art, it is apparent that the present application is not limited to the details of the foregoing exemplary embodiments, and the present application can be implemented in other specific forms without departing from the spirit or basic features of the present application. Therefore, from every perspective, the embodiments should be regarded as exemplary instead of restrictive, the scope of the present application is defined by the appended claims instead of the above description, and thus it is intended to include all changes falling within the meaning and scope of the equivalent requirements of the claims in the present application. Any reference signs in the claims should not be regarded as limiting the involved claims. In addition, it is apparent that the word “include” does not exclude other units or steps, and the singular form does not exclude the plural form. Multiple units or devices stated in the device claims may also be implemented by one unit or device through software or hardware. The “first”, “second” and other words are used to represent name, but do not indicate any specific order.

1. A resource processing method, comprising:
establishing, according to a first resource storage for storing a target source, a corresponding second resource storage, wherein the second resource storage comprises resource record information of the target resource;
according to a resource display mode corresponding to first resource storage, displaying the resource record information of the target resource; and
if the target resource is received by the first resource storage, updating the first resource storage according to the second resource storage.

2. The method according to claim 1, wherein the updating the first resource storage according to the second resource storage comprises:
obtaining an exclusive lock of the second resource storage;
transferring the resource record information of the target resource in the second resource storage into the first resource storage; and
releasing the exclusive lock of the second resource storage.

3. The method according to claim 1, wherein the method further comprises:
if a distribution request for the target resource is received, generating to-be-distributed information corresponding to the target resource according to the distribution request.

4. The method according to claim 3, wherein the if the target resource is received by the first resource storage, updating the first resource storage according to the second resource storage further comprises:
distributing the target resource in the first resource storage to a user corresponding to the distribution request according to the to-be-distributed information, and correspondingly updating the first resource storage and the to-be-distributed information.

5. The method according to claim 3, wherein the generating to-be-distributed information corresponding to the target resource according to the distribution request further comprises:
updating available information of the target resource in the second resource storage according to the to-be-distributed information.

6. The method according to claim 1, wherein the target resource comprises a physical resource or virtual resource.

7. The method according to claim 1, wherein the resource record information of the target resource comprises timeliness information corresponding to the target resource.

8. The method according to claim 7, wherein the resource record information of the target resource further comprises resource allocation information corresponding to the target resource.

9. The method according to claim 8, wherein the resource allocation information is inherited from resource allocation information in the first resource storage.

10. The method according to claim 1, wherein the establishing, according to a first resource storage for storing a target resource, a corresponding second resource storage, wherein the second resource storage comprises resource record information of the target resource comprises:
receiving resource acquisition indication information;
determining, according to the resource acquisition indication information, the first resource storage for storing the target resource corresponding to the resource acquisition indication information; and
establishing a corresponding second resource storage according to the first resource storage, wherein the second resource storage comprises the resource record information of the target resource.

11. A resource processing device, comprising:
a first unit, configured to establish, according to a first resource storage for storing a target resource, a corresponding second resource storage, wherein the second resource storage comprises resource record information of the target resource;
a second unit, configured to, according to a resource display mode corresponding to the first resource storage, display the resource record information of the target resource; and
a third unit, configured to, if the target resource is received by the first resource storage, update the first resource storage according to the second resource storage.

12. The device according to claim 11, wherein the updating the first resource storage according to the second resource storage comprises:
obtaining an exclusive lock of the second resource storage;
transferring the resource record information of the target resource in the second resource storage into the first resource storage; and
releasing the exclusive lock of the second resource storage.

13. The device according to claim 11, wherein the device further comprises:
a fourth unit, configured to, if a distribution request for the target resource is received, generate to-be-distributed information corresponding to the target resource according to the distribution request.

14. The device according to claim 13, wherein the third unit is further configured to:
distribute the target resource in the first resource storage to a user corresponding to the distribution request according to the to-be-distributed information, and correspondingly update the first resource storage and the to-be-distributed information.

15. The device according to claim 13, wherein the generating to-be-distributed information corresponding to the target resource according to the distribution request further comprises:
updating available information of the target resource in the second resource storage according to the to-be-distributed information.

16. The device according to claim 11, wherein the target resource comprises a physical resource or virtual resource.

17. The device according to claim 11, wherein the resource record information of the target resource comprises timeliness information corresponding to the target resource.

18. The device according to claim 17, wherein the resource record information of the target resource further comprises resource allocation information corresponding to the target resource.

19. The device according to claim 18, wherein the resource allocation information is inherited from resource allocation information in the first resource storage.

20. The device according to claim 11, wherein the first unit is configured to:
receive resource acquisition indication information;
determine the first resource storage for storing the target resource according to the resource acquisition indication information; and
establish a corresponding second resource storage according to the first resource storage, wherein the second resource storage comprises the resource record information of the target resource.
